(19) United States
(12) Patent Application Publication
(10) Pub. No.: US 2010/0036603 A1
(43) Pub. Date: Feb. 11, 2010

(54) NAVIGATION SYSTEMS AND NAVIGATION METHODS THEREOF

(75) Inventor: Fang-Wei Kang, Taipei City (TW)

Correspondence Address: QUINTERO LAW OFFICE, PC, 615 Hampton Dr, Suite A202, Venice, CA, 90291, US

(73) Assignee: MITAC INTERNATIONAL CORP., TAOYUAN (TW)

(21) Appl. No.: 12/501,367

(22) Filed: Jul. 10, 2009

(30) Foreign Application Priority Data
Aug. 6, 2008 (TW) TW97129794

(51) Int. Cl. G01C 21/00

(52) U.S. Cl. 701/201; 701/200

(57) ABSTRACT

Navigation methods for navigating an electronic device are disclosed. The method comprises the following steps. First, geographic data of a specific region having a plurality of installations is acquired in which each installation has an attribute data. The installations are classified by the electronic device to generate a plurality of candidate routes according to attribute data thereof. The candidate routes are displayed and a candidate route selection is received by the electronic device so as to perform navigation in the specific region based on the candidate route corresponding to the received candidate route selection.

### CROSS REFERENCE TO RELATED APPLICATIONS

This Application claims priority of Taiwan Patent Application No. 097129794, filed on Aug. 6, 2008, the entirety of which is incorporated by reference herein.

### BACKGROUND OF THE INVENTION

1. Field of the Invention

The disclosure relates generally to navigation systems and related navigation methods, and, more particularly to navigation systems and related navigation methods that provide navigation and route planning within a specific region such as a theme park.

2. Description of the Related Art

Global Positioning System (GPS) technology has been widely used in navigation systems of various electronic devices, such as portable devices and electronic devices in cars to receive signals from GPS satellites. Accordingly, the position of an electronic device with a GPS receiver therein, can be determined according to responsive positioning signals between the electronic device and the satellites. Users may also use navigation software in the electronic device for route planning and navigation.

As user requirements changes, navigation systems not only provide navigation on traveled roads, but also provide geographic data of specific regions such as geographic data of a zoo or a theme park. Currently, a user may obtain his current position within the specific region by referring to the current position calculated by navigation system and the geographic data of the specific region. Besides the positioning function and display introductions for the geographic data, navigation system, however, does not provide any further navigation information or functions within the specific region. Therefore, users may waste time seeking target installations within the specific region.

### BRIEF SUMMARY OF THE INVENTION

Navigation systems and related navigation methods for a specific region are provided so as to provide further navigation support within a specific region.

In an embodiment of a navigation method for navigating an electronic device. First, geographic data of a specific region having a plurality of installations is acquired, wherein each installation has an attribute data. The installations are then classified by the electronic device to generate a plurality of candidate routes according to attribute data thereof. The candidate routes are displayed and a candidate route selection is received by the electronic device so as to perform navigation in the specific region based on the candidate route corresponding to the received candidate route selection.

An embodiment of a navigation system for use in an electronic device comprises a display unit and a processing unit. The processing unit acquires geographic data of a specific region having a plurality of installations, wherein each installation has an attribute data. The electronic device classifies the installations to generate a plurality of candidate routes according to attribute data thereof, displays the candidate routes through the display unit and receives a candidate route selection so as to perform navigation in the specific region based on the candidate route corresponding to the received candidate route selection.

Navigation methods and navigation systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a navigation system of the invention;

FIG. 2A is a schematic diagrams illustrating an embodiments of a specific region of the invention;

FIG. 2B is a schematic diagrams illustrating an embodiment of an installation within the specific region of the invention;

FIG. 3 is a flowchart of an embodiment of a navigation method of the invention; and

FIG. 4 is a flowchart of another embodiment of a navigation method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide a navigation system and related navigation method for use in an electronic device such that all of the devices or installations within a specific region may be classified by their own attribute data and various suggested visiting routes are generated based on the classified result for user selection. Thus, users may select a suitable visiting route according to requirements. Furthermore, when current installation positions match predetermined conditions, a broadcasting message (such as a traffic message channel (hereinafter referred to as TMC) message) is generated to notify the electronic device so that the users may determine whether to manually add the new installation into the visiting route so that time is not wasted seeking target installations within the specific region.

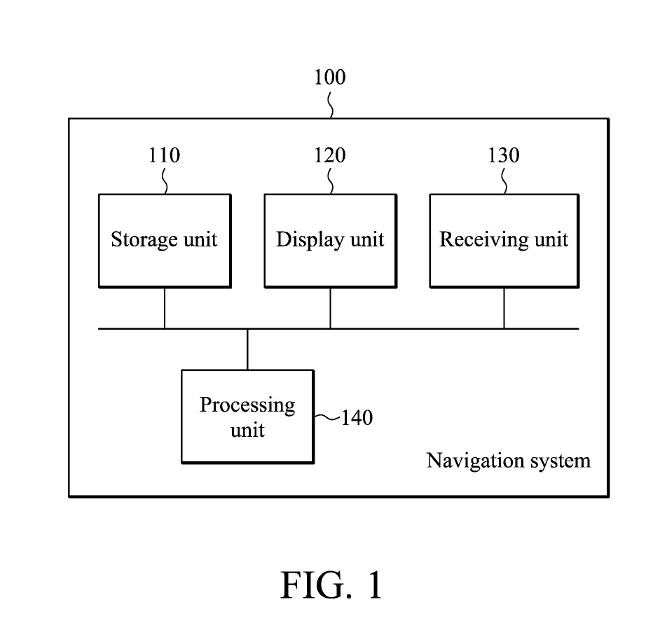

FIG. 1 is a schematic diagram illustrating an embodiment of a navigation system of the invention. Navigation system is suitable for use in an electronic device, such as a computer system or a portable device having a navigation function.

Navigation system 100 comprises a storage unit 110, a display unit 120, a receiving unit 130 and a processing unit 140. The storage unit 110 comprises map data or geographic data corresponding to at least one specific region, such as an area, a theme park or a country. The map/geographic data may comprise doorplate addresses, landmarks, scenic spots, and/or road and information thereof. For example, in one embodiment, if the specific region is a theme park, its map/geographic data may be a travel map for the theme park in which correct positions of all of the installations within the theme park may be illustrated thereon. The display unit 120 displays related data, such as a user interface, route planning results, and related navigation information.

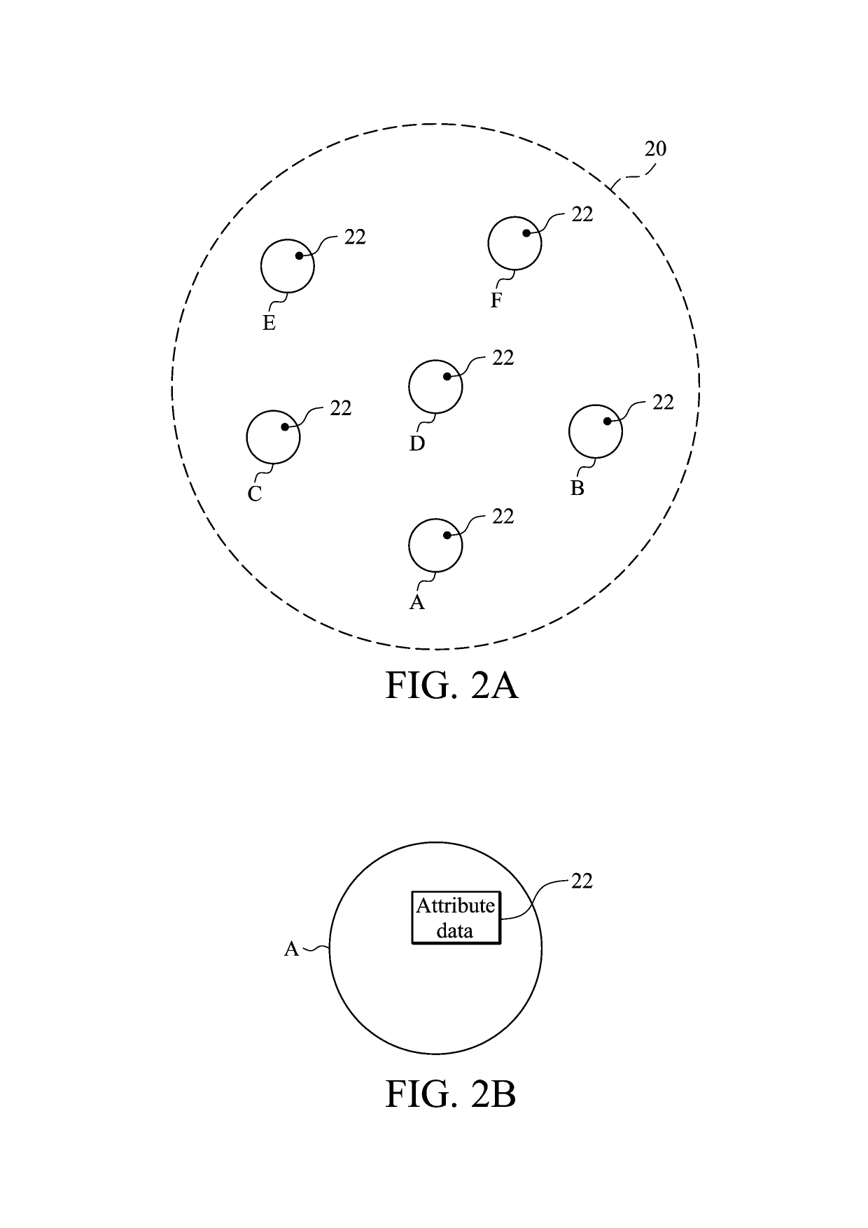

FIG. 2A is a schematic diagram illustrating an embodiment of geographic data of a specific region of the invention. FIG. 2B is a schematic diagram illustrating an embodiment of an installation within the specific region of the invention. As shown in FIG. 2A, the specific region 20 comprises installations A-F and corresponding positions within the specific region of each installation are plotted. Each of the installations A-F has a corresponding attribute data 22 as shown in FIG. 2B. The attribute data such as user characteristic data like the age of users and functionality of the installations may serve as classification data for classification. For example, in one embodiment, attribute data corresponding to each installation may be configured according to a specific condition such as the age range of users being under or above 12 years old.

The processing unit 140 may be a navigation engine having a route planning capability. Users may input navigation parameters, such as a starting point, a destination, and/or at least one mid-point via the user interface. The processing unit 140 performs route planning according to navigation parameters such as the starting point, the mid-point and the destination to obtain at least one route planning result. Users may be navigated to the destination according to a planned route which is obtained by the route planning result. The receiving unit 130 may receive a specific message, such as a broadcasting message (e.g. a TMC message). It is noted that, navigation system 100 may further comprise a signal receiving unit (not shown) to receive satellite signals. The processing unit 140 may then calculate current position of the electronic device based on the received signals. When the current position of the electronic device conforms to the route planning result, the processing unit 140 may proceed to provide navigation function to move the electronic device to the destination according to the original route planning result. When the electronic device moves into a specific region, the processing unit 140 may perform navigation within the specific region according to a navigation method of the invention. Navigation method of the invention is detailed in below.

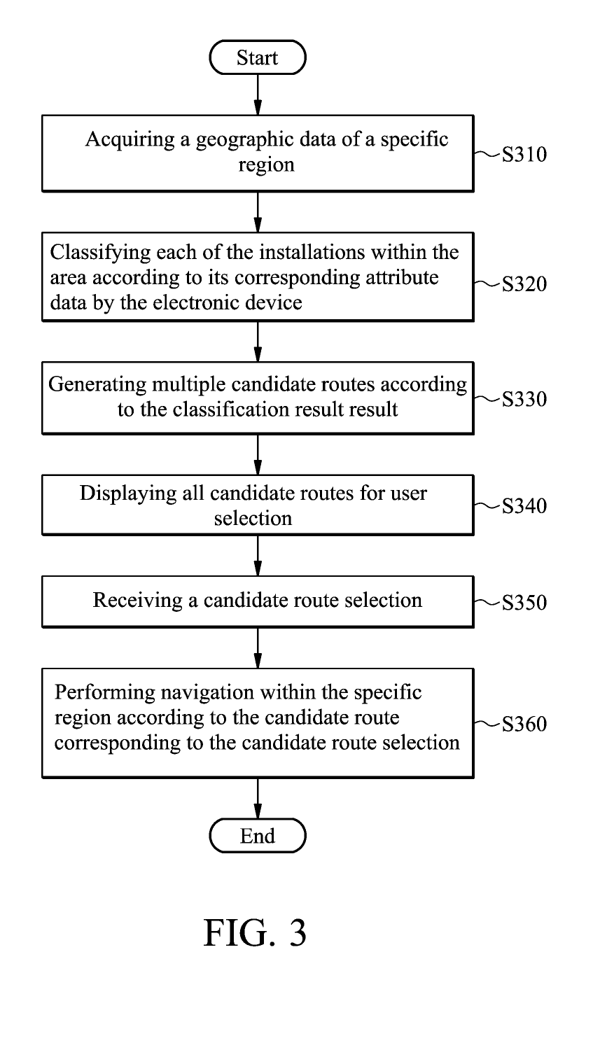

FIG. 3 is a flowchart of an embodiment of a navigation method of the invention. Navigation method is suitable for use in an electronic device, such as a computer system or a portable device having a navigation function.

In step S310, a geographic data of a specific region is first acquired in which the specific region has multiple installations and each installation has an attribute data corresponding thereto. For example, if the specific area is a zoo area or a theme park, step S310 will acquire a map for the zoo area or the theme park, wherein relative position of each installation within the zoo area or the theme park and its corresponding attribute data will be plotted on the map. It is to be noted that, in one embodiment, users may acquire the geographic data of the specific region by downloading the geographic data from a website and when the geographic data of the specific region has been modified, the geographic data of the specific region within the website may be accordingly modified. Therefore, the electronic device is capable of acquiring correct geographic data for further navigation.

Accordingly, in step S320, the electronic device classifies each of the installations within the area according to its corresponding attribute data. In this step, installations with the same attribute data will be classified into the same classification. Therefore, if three kinds of attribute data are applied to the installations, three corresponding classifications may be obtained. After completion of the classification, in step S330, multiple candidate routes will be generated according to the classification result. It is noted that, each candidate route may be a suggested visiting route for the specific region. Similarly, if three classifications are obtained, the electronic device may plan at least three corresponding candidate routes.

In step S340, the electronic device displays all candidate routes for user selection. Then, in step S350, the electronic device receives a candidate route selection. For example, users may choose one of the candidate routes via a user interface and/or configure content of a candidate route thereby, and then the electronic device will receive the candidate route selection of the user. When receiving the candidate route selection, in step S360, the electronic device may perform navigation within the specific region according to the candidate route corresponding to the candidate route selection. It is noted that, navigation system 100 may continuously receive satellite signals and calculate current position of the electronic device based on the received signals during navigation process. Therefore, users may obtain current positions and may determine which installation to go to.

For example, when users enter a theme park and after the positioning function is completed, a menu with multiple candidate routes may be popped up for the user to select one of the candidate routes. When a broadcasting message has been received, the electronic device may help to provide route re-planning (i.e. re-plan a new route) or display content of the message to notify the user that a new installation becomes available so that the users may determine whether to manually add the new installation into the visiting route.

For example, if the specific region is a theme park, then each installation of the theme park (i.e. installations of the theme park) may be classified according to a character such as whether the installation is suitable to be visited by people with an age range below 12 years old or above 12 years old, to generate an age range attribute data. Therefore, the installations of the theme park may be first divided into an animal area, a food area, a game area and a warm and cozy area, and then installations within each area may be further classified according to age range attribute data thereof. Thus, in this embodiment, the zoo area may be classified as route A, wherein the Lion area is classified as route A-1 (not for people under 12 years old), the Rabbit area is classified as route A-2 (suitable for people between ages from 1 to 12 years old), the Monkey area is classified as route A-3 (suitable for people between ages from 1 to 12 years old) and the Elephant area is classified as route A-4 (suit for people between ages from 1 to 12 years old). The food area may be classified as route F, wherein the hot food area is classified as route F-1, the vending machine is classified as route F-2, the ice cream area is classified as route F-3 and the peddler area is classified as route F-4. The game area may be classified as route E, wherein the Roller Coaster is classified as route E-1 (not for people under 12 years old), the carousel is classified as route E-2 (suitable for people between ages from 1 to 12 years old) and the dodgem is classified as route E-3 (not for people under 12 years old). The warm and cozy area may be classified as route I which comprises a breast-feeding area, toilet and rest area. When users arrive at the theme park, the electronic device may provide a popular route, e.g. a route which comprises the game area together with the zoo area, for the users if all of the users are older than 12 years old. If users are adults with children, the electronic device may provide a route for a children area such as a route which comprises the zoo area and the food area. If the user is an expectant mother, the electronic device may provide a route for the warm and cozy area. As movement of by expectant mother may be inconvenient, the electronic device may provide an installation with a shortest path from a current position according to the calculated current position.

Moreover, users may modify content of the planned candidate route and manually determine its content. The electronic device may add a “condition field” on the candidate route and a name of the route and content thereof may be edited by the user. The user may modify a portion or all of the content of the candidate route according to requirements via a suitable user interface so as to acquire a desired route.

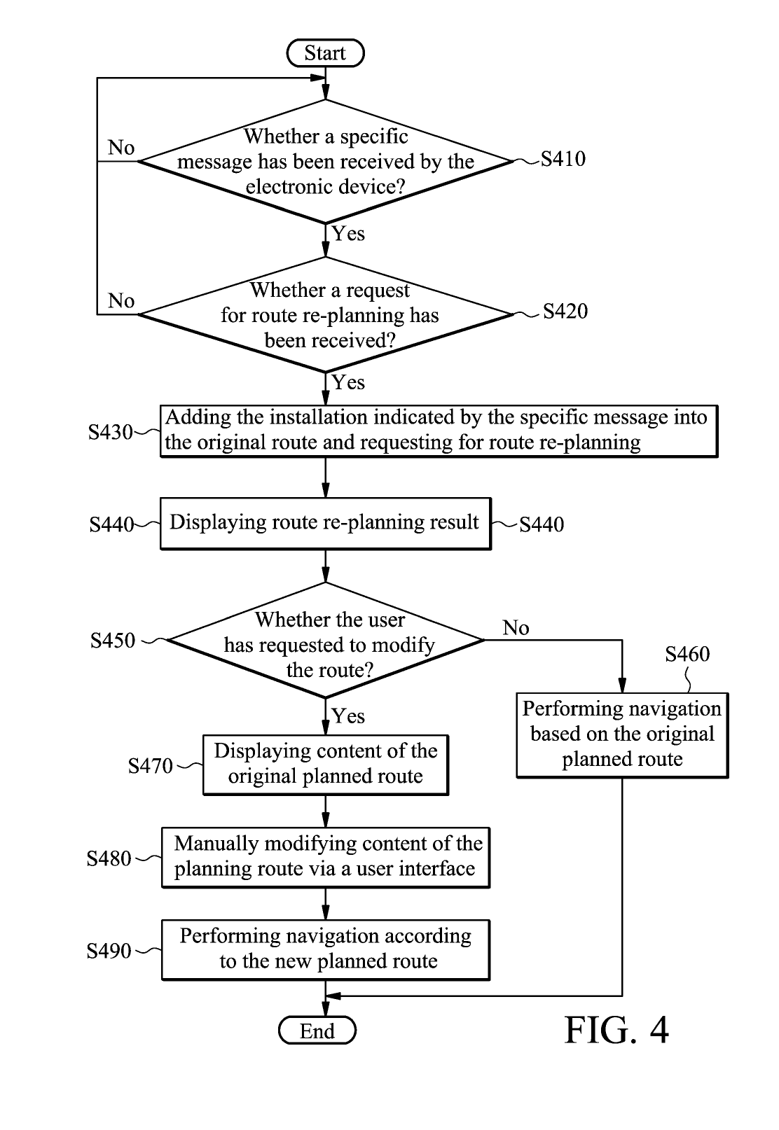

FIG. 4 is a flowchart of another embodiment of a navigation method of the invention. Similarly, navigation method is suitable for use in an electronic device, such as a computer system or a portable device having a navigation function.

First, it is determined whether a specific message has been received by the electronic device (step S410). In this embodiment, when status of a current loading of an installation (e.g. the number of persons currently using or the number of persons currently waiting to use the installation) matches a predetermined condition, the installation may issue a specific message to inform a server. The server may then transmit a message with a specific format (e.g. a TMC message) that has content corresponding to the installation to the electronic device. The specific message may comprise information about installations that is currently suited to be visited. The electronic device may receive the specific message via the receiving unit. When the electronic device does not receive the specific message (No in step S410), the original planned route will be kept and it is continually determined whether the electronic device has received a specific message. When the electronic device receives the specific message (Yes in step S410), it is then determined whether a request for route re-planning has been received (step S420).

If the user is not interested with content of the specific message and has not requested route re-planning, the process returns to step S410 for continually determining whether a specific message has been received by the electronic device. If the user attempts to add the installation indicated by the specific message into the original route and requests for route re-planning (Yes in step S420), the specific message is analyzed to obtain the installation corresponding thereto and the route planning function will be re-performed to re-plan a new route (step S430).

When re-planning of the new route has been completed, the electronic device may display the route re-planning result (step S440). Meanwhile, the installation indicated by the specific message will be added into the original planned route. Thereafter, it is determined whether the user has requested to modify the route (step S450). If not, navigation is continually performed based on the original planned route (step S460). If the user attempts to modify the original planned route, the content will be displayed for user review (step S470). Then, the electronic device may provide a user interface such that the user may manually modify content of the planning route as required via the user interface (step S480). For example, users may refer to the original planned route, then add or cancel some installation points to generate a new planned route via the user interface, and perform navigation according to the new planned route (step S490).

In summary, according to navigation system and related navigation method of the invention, when moving into a specific region such as a zoo or a theme park, the electronic device can classify the installations within the specific region based on its attribute data or user characters to generate a plurality of planned routes for user selection and therefore provide efficient navigation for user, significantly reducing time for seeking target installations within the specific region and improving user convenience.

Navigation systems and navigation method thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A navigation method for navigating an electronic device, comprising:
acquiring geographic data of a specific region having a plurality of installations, wherein each installation has an attribute data;
classifying the installations by the electronic device to generate a plurality of candidate routes according to attribute data thereof; and
displaying the candidate routes and receiving a candidate route selection by the electronic device so as to perform navigation in the specific region based on the candidate route corresponding to the received candidate route selection.

2. The navigation method of claim 1, further comprising:
receiving an attribute data input; and
automatically performing navigation based on the candidate route corresponding to the received attribute data input.

3. The navigation method of claim 2, wherein the attribute data is related to age data of a user and the electronic device generates a plurality of candidate routes based on the age data of the user.

4. The navigation method of claim 1, further comprising:
displaying content of the selected candidate route; and
providing a user interface for modifying the content of the selected candidate route by a user.

5. The navigation method of claim 4, wherein the step of performing navigation in the specific region further comprises:
receiving a specific message; and
displaying the specific message for notifying the user that a new installation becomes available and directing the user to determine whether to manually add the new installation into the selected candidate route.

6. The navigation method of claim 5, wherein the specific message is a traffic message channel (TMC) message.

7. The navigation method of claim 5, further comprising:
re-planning a route in the candidate route based on content of the specific message when user requests to re-plan the route.

8. The navigation method of claim 1, further comprising:
acquiring a current position of the electronic device; and
generating a candidate route according to distances between the current position and each of the installations.

9. The navigation method of claim 8, wherein the step of generating a candidate route according to distances between the current position and each of the installations is generated based on a shortest path rule.

10. The navigation method of claim 1, wherein the specific region is a theme park and the installations are installations of the theme park.

11. A navigation system for use in an electronic device, comprising:
a display unit; and
a processing unit, acquiring geographic data of a specific region having a plurality of installations, wherein each installation has an attribute data,
wherein the electronic device classifies the installations to generate a plurality of candidate routes according to attribute data thereof, displays the candidate routes through the display unit and receives a candidate route selection so as to perform navigation in the specific region based on the candidate route corresponding to the received candidate route selection.

12. The navigation system of claim 11, wherein the processing unit further receives an attribute data input and automatically performs navigation based on the candidate route corresponding to the received attribute data input.

13. The navigation system of claim 12, wherein the attribute data is related to an age data of a user and the electronic device further generates the candidate routes based on the age data of the user.

14. The navigation system of claim 11, wherein the electronic device further displays content of the selected candidate route and provides a user interface for modifying the content of the selected candidate route by a user.

15. The navigation system of claim 11, further comprising a receiving unit for receiving a specific message, wherein the display unit displays the specific message for notifying the user that a new installation becomes available and directing the user to determine whether to manually add the new installation into the selected candidate route.

16. The navigation system of claim 15, wherein the specific message is a traffic message channel (TMC) message.

17. The navigation system of claim 15, wherein the processing unit further re-plans a route in the candidate route based on content of the specific message when a user requests to re-plan the route.

18. The navigation system of claim 11, wherein the processing unit further acquires current position of the electronic device and generates a candidate route according to distances between the current position and each of the installations.

19. The navigation system of claim 18, wherein the processing unit further generates the candidate route based on a shortest path rule.

20. A machine-readable storage medium comprising a computer program, which, when executed, causes a device to perform a navigation method, and the method comprising:
acquiring geographic data of a specific region having a plurality of installations, wherein each installation has an attribute data;
classifying the installations by the electronic device to generate a plurality of candidate routes according to attribute data thereof; and
displaying the candidate routes and receiving a candidate route selection by the electronic device so as to perform navigation in the specific region based on the candidate route corresponding to the received candidate route selection.
